(19) United States
(12) Patent Application Publication
(10) Pub. No.: US 2020/0012283 A1
(43) Pub. Date: Jan. 9, 2020

(54) SYSTEM AND METHOD FOR AUTONOMOUS MARITIME VESSEL SECURITY AND SAFETY

(71) Applicant: Vu Xuan NGUYEN, Vancouver, WA (US)

(72) Inventor: Vu Xuan NGUYEN, Vancouver, WA (US)

(21) Appl. No.: 16/156,849

(22) Filed: Oct. 10, 2018

Related U.S. Application Data
(60) Provisional application No. 62/694,077, filed on Jul. 5, 2018.

(51) Int. Cl. G05D 1/02; G05D 1/00; G08G 3/02

(52) U.S. Cl. CPC G05D 1/0206; G05D 1/048; G08G 3/02; G05D 1/0088

(57) ABSTRACT

An autonomous boat capability for man or unmanned vessels to build a contextual understanding of the marine environment to identify situations of collisions, man-overboard, intrusion and taking appropriate action based on context. This includes imaging (conventional camera, ToF camera, depth camera, thermal cameras, radar, lidar) and audio (microphone, sonar, sonic) sensors, compute device to build environmental understand, recognition, and compute optimal route navigation, controller to manage heading, controller to handle propulsion, display for latest marine information and navigation data, speakers to alert crew, horn to signal to other vessels.

### CROSS REFERENCE TO RELATED APPLICATIONS

This application claims the benefit of U.S. Provisional Patent Application No. 62/694,077, entitled SYSTEM FOR CONTEXTUAL UNDERSTAND FOR AUTONOMOUS BOAT SAFETY AND SECURITY, filed on Jul. 5, 2018. The contents of this application is hereby incorporated by reference in its entirety.

### FIELD OF THE INVENTION

The present invention relates to the field of autonomous maritime vessel navigational safety and security utilizing imaging and audio sensors, computer vision, and machine learning. Embodiments of the present invention provide for a piloted and/or non-piloted marine vessel facilitating and supporting autonomous onboard capabilities for safety (i.e. collision avoidance, man-overboard, etc.) and security (i.e. intrusion, illegal boarding, etc.).

### BACKGROUND OF THE INVENTION

Demand for mariner vessels has increased; and, therefore maritime navigation and safety and security has also become increasing more challenging. Although there have been incremental improvements of various related technologies, the marine industry generally lags on technology development as compared to their counterpart on land and in the air. Today, the mechanism for safety is essentially more of a certification of competency or licensing for vessel pilots and boat operators in the hopes of reducing collision and other dangers of navigation. In autonomous vessel fields, systems are being developing capable to detect other vessels through radar, association of information systems (AIS), or depth ranging cameras. Such known systems are primarily used for course correction; however, existing systems do not have “a context” to determine for example vessel right-of-way or account for non-hazards. For example, a pilot probably would not want to course correct because dolphins are swimming at the bow; but, would definitely need to navigate around a gray whale or pod of grays whales which would pose a distinct hazard. Another example is, under international maritime right-of-way regulations, a small power boat must give way to a large container ship. Today, a large autonomous container ship would navigate to avoid the small nimbler vessel; which is the incorrect action in terms of right-of-way, is inefficient from an energy and fuel use perspective, and can be a hazard in narrow shipping vessel channels.

For maritime man-overboard events, known and common safety mechanisms include personal life jackets with beaconing devices. Some known devices may include satellite communication capabilities to call to shore for eventual help. However, rescuers may take days if a castaway is far from land. Moreover, global positioning systems (GPS) is not always accurate. Additionally, such devices batteries only last usually one or two days before failure. Depending on conditions, some castaways only have minutes to be found and retrieved before exposure fatally takes its toll. Known low-power local broadcasting devices work within a limited range, typically need to be above the water surface, and must deployed before an underway vessel is out of communication range. The best chance of rescue is to immediately identify if someone overboard via a spotter keeps an eye on the person overboard, and crew must immediately perform man-overboard rescue maneuvers. Even with the latest technology, because of delayed initial detection and recovery, many people are even today lost at sea. A recent example of man-overboard occurred during the renowned Volvo Ocean Race, where a team with state-of-the-art technology lost a person at sea because they did not detect the man-overboard scenario quick enough and the technology they did have failed.

Security measures are usually nonexistent on marine vessels; but, theft and piracy around the world is on the rise. If measures do exist, such security systems typically include conventional door and hatch sensors similar to home or business security systems. Consequently, theft may happen on deck as well via the many unsecured doors, hatches and port windows. The best way to protect against maritime vessel theft is to detect a potential intruder before they board the vessel. The main known vessel theft countermeasure today is rather archaic; the crew is to keep watch.

With billions of dollars of cost, crew safety, collisions, and theft accounting for a substantial amount if not the majority of the cost of operating a maritime vessel; there is little practical technology available to assist in these areas.

Existing systems include US 2017/0259893, US 2017/0210449, US 2016/0266246, U.S. Pat. Nos. 9,106,810, 9,729,802, US 2016/0031536, U.S. Pat. Nos. 9,183,711, 9,223,310, US 2013/0201316, U.S. Pat. Nos. 8,531,316, 8,180,507, 8,996,210, US 2006/0276943, U.S. Pat. Nos. 7,099,755, 6,647,328, and 6,269,763. However, these prior art references are deficient as they do not provide

Accordingly, the present invention is directed to solving all of these problems.

### SUMMARY OF THE INVENTION

Objects of the invention are achieved by providing maritime hazard mitigation system and methods thereof that have a contextual understanding of the marine environment to identify situations of collusions.

Objects of the invention are achieved by providing maritime hazard mitigation systems and methods thereof that are configured to recognize a marine environment to identify situations of collusions.

Objects of the invention are achieved by providing maritime hazard mitigation systems and methods thereof that provide a contextual response to a marine environment and maritime hazard situation.

In a first aspect, the invention provides a method for maritime hazard mitigation on a maritime vessel, the method comprising the steps of: providing a maritime vessel; providing a maritime hazard mitigation system onboard the maritime vessel, the maritime hazard mitigation system comprising: at least one computer having a processor, software executing on the processor, and a data storage, and at least one sensor in communication with the at least one computer, wherein maritime data is loaded onto the data storage, the maritime data including information stored on a database including a marine data model; wherein upon operation of the maritime vessel, the maritime hazard mitigation system is configured to: detect at least one maritime object via the at least one sensor; associate the at least one maritime object with the marine data model stored on the database; determine a navigation maneuver for the maritime vessel based upon the association between the at least one maritime object and the marine data model stored on the database; and conduct a navigation maneuver by the maritime vessel.

In one or more embodiments, the maritime objects include objects selected from a group consisting of boats, marine platforms, sea life, people, buoys (i.e. aid to navigation, fishing, isolated danger marks, etc.), floating hazards (i.e. containers, shipwreck, mooring, lines, etc.), ground (i.e. shoals, rocks, reefs, shore, etc.), weather (i.e. squalls, wind buffs, lightening, etc.), and combinations thereof.

In one or more embodiments, the step of associating the at least one maritime object with information stored on the database includes processing a machine learning algorithm.

In one or more embodiments, the information stored on the database includes contextual responses to a possible vessel collision, a man-overboard scenario, and hostile or illegal vessel boarding information.

In one or more embodiments, the marine data model is a neural network model.

In one or more embodiments, the maritime vessel includes an onboard local network.

In one or more embodiments, the navigation maneuver of the maritime vessel is conducted autonomously without human intervention.

In one or more embodiments, the maritime hazard mitigation system is configured to recognize an emergency situation and provide a contextual based approach to performing the navigation maneuver to avoid the emergency situation. In certain embodiments, an emergency situation is selected from a situation where the ship may become damaged, hit another ship, and/or hit a set of other marine objects (i.e. rocks, floating containers, buoys, etc.).

In yet another aspect, the invention provides a maritime hazard mitigation system, comprising: a computer including a processor, a data storage including a database storing information in communication with the processor, the data storage being loaded with information including a marine data model, and software executing on the processor configured to detect at the least one maritime object via at least one image sensor via at least one sensor; wherein the software executing on the processor compares the at least one maritime object with information stored on the database including the marine data model, and sends a corresponding signal to conduct a vessel navigation maneuver to avoid anticipated vessel collision with the at least one maritime object.

In one or more embodiments, the maritime hazard mitigation system is onboard the maritime vessel.

In one or more embodiments, the maritime vessel is autonomous and equipped with automated propulsion control and navigation control systems.

In certain embodiments, the computer includes a neural network capable of heuristic machine learning to update the database with additional maritime and other information.

In yet another aspect, the invention provides a system for contextual understanding for autonomous boat safety and security, comprising: at least one imaging sensor, at least one audio sensor, a computer including a processor, a storage, network hardware, and a global positioning system (GPS), the network hardware in communication with the computer and the at least one image sensor and the at least one audio sensor to establishing a local area network in further communication to with the Internet; software executing on the processor for recognition of maritime objects via algorithms and digital signal processing; a stream of data from the at least one image sensor and the at least one audio sensor configured to be analyzed and processed into a stream of environmental conditions and stimuli, a set of pre-determined contexts stored in the storage relevant to maritime vessels in continuously changing environmental conditions; and, a dynamic context derived by the computer based on the current state of the environmental conditions, wherein the software executing on the processor continuously executes a decision algorithm that calculates an optimized vessel action based on the dynamic context.

In one or more embodiments, the dynamic contexts from the current state of the environment and optimized vessel action are displayed on an electronic display for viewing by a system user.

In one or more embodiments, the dynamic contexts from the current state of the environment and optimized vessel action are communicated to nearby mobile devices, vessels, and backup systems.

In one or more embodiments, the imaging sensor type is selected from the group consisting of visible wavelengths, hyperspectral wavelengths, infrared wavelengths time-of-flight, depth of field or ranging, microwave wavelengths, radio wavelengths, thermo, and combinations thereof

In one or more embodiments, the at least one audio sensor is selected from the group consisting of mic-array, microphone, sonar, ultrasound, sonic and combinations thereof.

In one or more embodiments, the algorithm utilizes data corresponding to collision standards from the international, regional, or local standards for collision and waterway regulations, such as COLREG-1972. In certain embodiments, the algorithm utilizes regulatory standards of regional rules.

In one or more embodiments, the dynamic context includes an intruding vessel determined by interception course from a database of dangerous vessels and the optimized vessel action is to sound an alarm or evade.

In one or more embodiments, the dynamic context includes a man-overboard event and the optimized vessel action is to locate and track the man-overboard object.

In one or more embodiments, the dynamic context includes an object collision event and the software is configured to discriminate between a smart-avoiding object which can itself enact mutual avoidance directives, or a non-self-avoiding object where the optimized vessel action is to actively avoid collision with the non-self-avoiding object.

In one or more embodiments, the algorithm utilizes generic contexts for a majority of maritime environments.

In one or more embodiments, the algorithm utilizes custom or specific contexts for specialized maritime environments.

In one or more embodiments, the set of contexts includes stimuli from different environmental conditions, selected from a group consisting of day, night, rain, clear, cloudy, seasons, and combinations thereof.

In yet another aspect, the invention provides a system for contextual understanding for autonomous boat safety and security, comprising: at least one sensor; a data acquisition device that records a continuous stream of data obtained by the sensor; wherein the continuous stream of sensor data is processed by a computer and a set of data features is extracted, wherein the processed data features are used as input into a machine learning algorithm, wherein the machine learning algorithm has been pre-populated with exemplar data to yield an output, wherein the output is utilized for subsequent actions.

In one or more embodiments, the machine learning algorithm is selected from but not limited to a group consisting of neural networks, support vector machines, decision trees, Bayesian algorithm, k-nearest neighbors algorithm, radial basis function network, linear regression, logistic regression, or a combination thereof.

In one or more embodiments, the object detection system is selected from but not limited to a group consisting Single Shot Detectors (SSD), You Only Look Once detector (YOLO), Regional Convolutional Neural Network (R-CNN), Faster R-CNN, Regional Fully Convolutional Network (R-FCN), RetinaNet, Feature Pyramid Networks (FPN), or a combination thereof.

In one or more embodiments, the exemplar data is from average maritime environments selected for general and/or routine output behavior.

In one or more embodiments, the exemplar data is from specific maritime environments selected for a specialized output behavior.

In one or more embodiments, the inputs and outputs of the system are displayed on an electronic display for viewing by a system user.

In one or more embodiments, the inputs and outputs of the system are transmitted wirelessly to mobile devices, vessels, and backup systems.

In yet another aspect, the invention provides a maritime autonomous system for building contextual understanding and deciding optimal strategy, comprising: a recognition module for situational collisions, a protocol module for man-overboard events, a scanning method for intrusion based on intercepting vessels, and a paradigm for taking appropriate action based on the context.

In yet another aspect, the invention provides a method for establishing maritime autonomous system behavior, comprising: receiving data from a plurality of sensors; parsing the data for salient features; analyzing the salient features with either a general artificial intelligence algorithm or a specific algorithm updated with a data set of mission-specific features; weighing the analysis and deciding an optimal action; communicating the decided upon optimal action and other possible actions, allowing the user to terminate or otherwise change the optimal action for an autonomous maritime vessel.

In one or more embodiments, an existing vessel may be equipped for automated propulsion control and navigation control and for autonomous features or display for instructions to the operator and audio to alert both crew as well as other vessels. The display and audio device do not necessarily need to be built into the ship as an implementation would be to transmit this information to personal mobile devices with display and audio.

In one or more embodiments, sensor information may be aggregated across different buses to the computer, for example including but not limited to NEMA, CANBus, and IEEE 802.3. Control systems of the vessel may be likewise connected to the inventive system computer.

Unless otherwise defined, all technical or/and scientific terms used herein have the same meaning as commonly understood by one of ordinary skill in the art to which the invention pertains. Although methods and materials similar or equivalent to those described herein can be used in the practice or testing of embodiments of the invention, exemplary methods or/and materials are described below. In case of conflict, the patent specification, including definitions, will control. In addition, the materials, methods, and examples are illustrative only and are not intended to be necessarily limiting.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic diagram of an embodiment of the invention.

FIG. 2 is a flowchart of required versus optional components of an embodiment of the invention.

FIG. 3 shows a camera system of an embodiment of the invention.

FIG. 4 shows a mic array of an embodiment of the invention

FIG. 5 is a flowchart regarding having a visual process to locate a marine object.

FIG. 6 a flowchart of a visual process for an object recognition.

FIG. 7 is a flowchart of visual tracker information.

FIG. 8 is a flowchart of an audio process.

FIG. 9 shows a neutral network for object recognition

It should be appreciated that for simplicity and clarity of illustration, elements shown in the figures have not necessarily been drawn to scale. For example, the dimensions of some of the elements are exaggerated relative to each other for clarity. Further, where considered appropriate, reference numerals have been repeated among the figures to indicate corresponding elements.

### DETAILED DESCRIPTION OF THE INVENTION

It is understood that the invention is not limited to the particular methodology, devices, items or products etc., described herein, as these may vary as the skilled artisan will recognize. It is also to be understood that the terminology used herein is used for the purpose of describing particular embodiments only and is not intended to limit the scope of the invention. The following exemplary embodiments may be described in the context of articles for ease of description and understanding. However, the invention is not limited to the specifically described products and methods and may be adapted to various applications without departing from the overall scope of the invention. All ranges disclosed herein include the endpoints. The use of the term “or” shall be construed to mean “and/or” unless the specific context indicates otherwise.

The present invention relates to maritime hazard mitigations and methods thereof that provide for a contextual understanding of a marine environment to identify situations of collisions, man-overboard, intrusion and taking appropriate action based on context. This includes imaging (conventional camera, ToF camera, depth camera, thermal cameras, radar, lidar) and audio (microphone, sonar, sonic) sensors, compute device to build environmental understand, recognition, and compute optimal route navigation, controller to manage heading, controller to handle propulsion, display for latest marine information and navigation data, speakers to alert crew, horn to signal to other vessels.

In one or more embodiments, using at least one sensor and computer onboard a marine vessel, the invention includes a pre-programmed and real-time updated neural network leveraging known machine learning algorithms to recognize marine environment objects and autonomously navigate based on an updated marine contextual environment in response to possible collision, man-overboard scenarios, and/or if there is a hostile or illegal boarding of the vessel.

In one or more embodiments, one or multiple sensors are provided capable of measuring distance and/or imaging an object above the water, on the water, and/or under the water. Some of these sensors may be conventional visible light sensors with low brightness or night vision capabilities, time-of-flight (ToF) cameras, depth or distance ranging cameras, thermal (both far and near infrared) cameras, radar (microwave frequency transceivers), lidar (a method that measures distance to a target by illuminating it with a pulsed laser and measuring the reflected pulses with a sensor), microphone, sonar, and/or sonic/audio sensors.

A “vessel” as herein defined includes a plurality of marine boats or ships (e.g. ferries, sailboats, containers ships, luxury superyachts, etc.) as well as marine platforms (e.g. oil platform, floating restaurants, docks, marinas, etc.).

“Image recognition” as herein defined is the ability to identify different category or class of objects or a specific object, depending on the use case, using imaging sensors and devices. An example of a technique is defined by https://arxiv.org/pdf/1512.02325. The method is used to detect objects in images using a single deep neural network.

“Training” as herein defined as a teaching a neural network on a particular training data set. For object classification or recognition, this will require a large data set or leverage re-training of existing neural network models. An example of such techniques is defined by https://github.com/balancap/SSD-Tensorflow.

“Audio recognition” as herein defined is the ability to identify different types of sounds including communication and distress signals, using audio sensors and devices. An example of such techniques is defined by http://marf.sourceforge.net/docs/marf/0.3.0.5/report.pdf.

“Image tracking” as herein defined is the ability to locate a recognized object and to map its path in 3D space with imaging sensors and devices.

“Audio tracking” as herein defined is the triangulation of sound including associating sounds to a recognized object and to map its path in 3D space with an audio sensors and devices. An example of such technique is defined by https://open.library.ubc.ca/media/download/pdf/24/1.0357459/4.

“Contextual action” as herein defined as action leveraging information related to marine objects that are detected or recognized. The action is based on preprogrammed local waterway rules, calculating safest course or to minimize damage or injury, and generic navigation technique based on seascape and weather. Optional a solution may incorporate human manual training for situation or adaptive adjustment for ship characteristic based on seascape and weather, leveraging neural network(s), providing for continuous improvement.

“Machine learning” is an application of artificial intelligence (AI) that provides systems the ability to automatically learn and improve from experience without being explicitly programmed. Machine learning focuses on the development of computer programs that can access data and use it learn for themselves.”

The present invention involves recognition of objects in the marine environment to support safety (collision avoidance, man-overboard) and security (intrusion), including appropriate maneuvering of the inventive vessel system, using imaging and audio devices capability of audible signal through horns or electronic communication, and of displaying information alerting the crew.

In one or more embodiments, through visual recognition and continuous tracking of marine objects (other ships, navigation buoy, land, etc.), the inventive system takes contextual action for collision avoidance based on local waterway rules when applicable, using imaging and audio devices.

In one or more embodiments, through audio recognition and tracking of marine sounds and signals, the inventive system takes contextual action for collision avoidance based on the local waterway rules when applicable in low visibility situations, communicating with audible signals or electronic communication with other vessels, using audio devices.

In one or more embodiments, through imaging and audio recognition and continuous tracking of marine sea life, the inventive system takes contextual action for navigation based on the type of sea life and collision hazard, using imaging and audio devices.

In one or more embodiments, through imaging and audio recognition and continuous tracking of mariner hazards (floating containers, fisherman buoy, etc.), the inventive vessel system takes contextual action based on the object and collision hazard, using imaging and audio devices.

In one or more embodiments, through imaging recognition and continuous tracking of cloud formation and lightening, the inventive vessel system may take appropriate action to avoid colliding with weather hazards, using imaging devices.

In one or more embodiments, through audio recognition and triangulation thunder, the inventive vessel system may take appropriate action to avoid colliding with lightening hazards, using audio devices.

In one or more embodiments, through imaging and audio recognition and continuous tracking of crew on deck, immediately identify when a person(s) is in the water, maneuvering for safe recovery of the person(s), alerting crew on person overboard, using imagining and audio devices.

In one or more embodiments, through imaging and audio recognition and continuous tracking of crew that is overboard, the system continues to track them and predicts their position when “out-of-sight” (not trackable) until they are acquired again, maneuvering for safe recovery of person, providing crew with location of person on display, using imaging and audio devices.

In one or more embodiment, the predictive tracking in the water takes into account wind, current, and waves, including last known location and speed of person overboard.

In one or more embodiments, through imaging and audio recognition and continuous tracking of vessels at sea, identify vessels that are on intercept course, taking additional evasive maneuver if appropriate and setting appropriate alert for operator, using imaging and audio devices.

In one or more embodiments, through imaging recognition and continuous tracking of people boarding, the vessel immediately alerts the crew if boarding was not expected, using imaging devices.

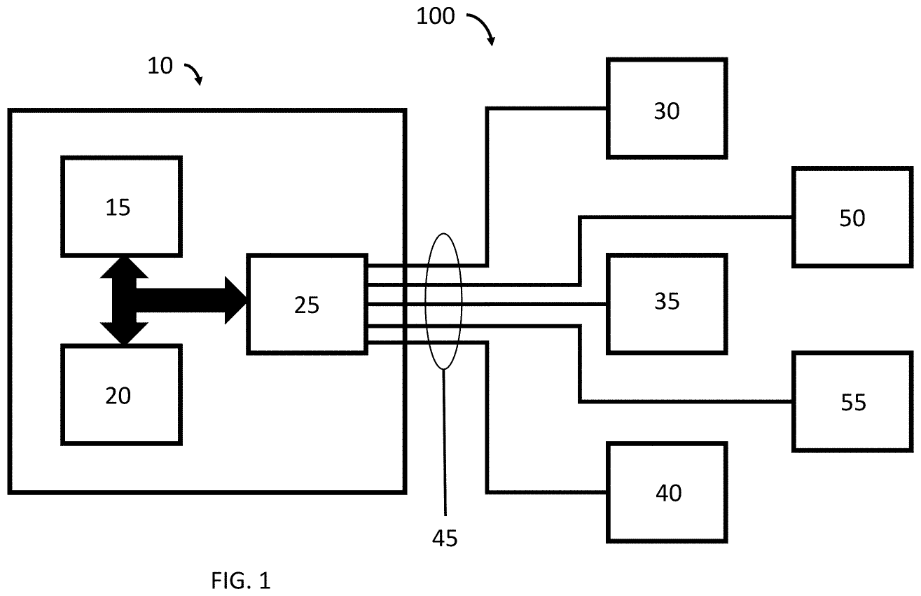

Referring to FIG. 1, in certain embodiments of the invention, the inventive vessel system (100) includes a computer (10) which may comprise of a combination of CPUs, GPUs, and DSPs, FPGAs, and/or other reprogrammable hardware devices, to efficiently handle the processing of sensor (30, 35) and other information (40, 50, 55) to calculate corrective navigational courses.

In certain embodiments of the invention, the inventive system computer (10) may include a processor (15) a memory or storage (20) and a network interface (25). Via either wired or wireless network connections (45), the processor (15) is in control and communication with imaging sensors (30), audio sensors (35), and other sources of real-time information (40) collected from the internet, GPS receiver systems, maritime radar systems, lidar systems, sonar systems, and the like. In certain embodiments, the inventive system computer (10) may interface with existing vessel subsystems such as vessel auto pilot (50) bridge navigation control (55), and other vessel subsystems.

In certain embodiments of the invention, the inventive system computer (10) may initially be pre-programmed or pre-loaded with a neural network model (900) that has been pre-trained with numerous examples of objects in a marine environment that the vessel may or will encounter. The pretrained object examples may encompass imagery of objects in a plurality of different conditions that are representative of the marine environment the vessel may or will encounter. For example, photos of boats of different classes, both day and night, in different weather conditions may be used for pre-programing the inventive system for sea-craft recognition. An adequate set of example maritime objects may include other common marine vessels, sea life, people, common marine objects (e.g. buoys, moorings, floating containers, lines), and key marina objects. Existing generic navigational databases may also be programmed into the inventive neural network(s).

In certain embodiments of the invention, the inventive system computer (10) may initially be pre-programmed or pre-loaded with contextual information about objects that is recognized by the neural network model (900). Each category of marine environment objects will need a set of data that provides information that help with safety and security of the inventive vessel system (100). For example, the boat data may contain information about size, type of vessel, capabilities, and unique water way rules regarding vessel. In another example, sea life data maybe contain information regarding size, risk of damage, and intelligence.

In certain embodiments of the invention, the inventive system computer (10) utilizes a neural network to classify or recognize images of marine objects. There are many different such options to selection from. One such example, leverage Single Shot Multibox Detectors, which provides for a real-time recognition with reasonable accuracy. An example of such technique is defined by https://arxiv.org/pdf/1512.02325.

In certain embodiments of the invention, the inventive vessel system (100) computer (10) may be preprogrammed with generic maritime data and augmented and/or reprogrammed for a particular vessel action with updated data.

In certain embodiments of the invention, the inventive vessel system (100) may archive in storage (15) updated maritime data to provide reference or historical update data to the inventive computer (10) to provide to a system (100) user, training methodologies including recommended approaches to particular maritime scenarios.

With known technologies, sensors generally provide rough coordinates of detected objects based on measured distance from a sensor or a plurality of sensors with accuracy dependent on the technology being used. For example, maritime radar can detect the distance of an object from the radar transmitter and provide a long-range view of the maritime environment, but with overall course or low accuracy resolution. Lidar uses a similar approach, but measures vessel emitted, and object reflected, laser light and is most accurate at close range with often to-the-centimeter accuracy. Although these signal emitting systems can inform a vessel and crew that something is “in the marine environment”, they cannot identify “what the something detected “is”; or “why the detected object is there”. The inventive vessel system and method provides this information using imagery and audio sensor data to recognize and provide a contextual detection of a maritime object and formulate an appropriate vessel action or response.

In certain embodiments of the invention, the inventive vessel system and method (100) recognizes other vessels on the water including the kind of vessel and performs contextual actions or responses based on pre-programmed rules defined by a region of operation.

For example, international standards for collision prevention may be found at: http://www.jag.navy.mil/distrib/instructions/COLREG-1972.pdf and are hereby incorporated by reference in its entirety. In certain embodiments of the invention, the inventive vessel system (100) would be preprogrammed with data corresponding to such a standard. For example, a power boat overtaking a sailboat must give way to avoid collision based on the standard. If the sailboat was equipped with this the inventive vessel system (100) on a non-imminent collision path, the inventive system (100) would recognize that there is a power boat approaching and the inventive system (100) does not needs to take action to adjust vessel course. However, if the power boat had not corrected course and collision would indeed be imminent if no inventive system (100) vessel action was taken, then the sailboat with the inventive system (100) would navigate away of the collision path accounting for all other system (100) detected and recognized hazards.

In certain embodiments of the invention, the inventive vessel system (100) may be pre-programmed and/or re-programmed with data corresponding to unique maritime hazards; such as weather hazards, man-made hazards, and marine environment hazards.

In one or more embodiments, the inventive vessel system (100) may be pre-programmed and/or re-programmed and include multiple camera sensors (30) aided by radar and/or lidar (40) to detect and categorize environmental weather hazards such as lightning storms and strikes, squalls, water spouts, high seas, high winds, and other weather related hazards.

In one or more embodiments, the inventive vessel system (100) may be pre-programmed and/or re-programmed and include multiple camera sensors (30) aided by radar, lidar, and sonar (40) to detect and categorize man-made hazards such as Aid to Navigation (ATON) buoys, other buoys, drifting containers, abandoned vessels adrift, and shipwrecks.

In one or more embodiments, the inventive vessel system (100) may be pre-programmed and/or re-programmed and include multiple camera sensors (30) aided by lidar and sonar (40) to detect and categorize marine environment hazards such as reefs, land, tidal shoals, and sea-life of a size capable of damaging the vessel. For example, in the case of hazards such as ATON buoy, the inventive vessel system (100) would navigate and avoid collision by following the rules defined by the ATON. In the case of an intelligent maritime object, such as dolphins which are capable of collision avoidance, it is contemplated that the inventive vessel system (100) may possibly take no action depending upon the totality of the maritime context.

In one or more embodiments, the inventive vessel system (100) may be pre-programmed and/or re-programmed and include multiple camera sensors (30) to take an action of alerting and/or warning vessel crew and other vessels if a collision of these objects is predicted to be unavoidable.

In one or more embodiments, the inventive vessel system (100) may be pre-programmed and/or re-programmed and include multiple camera sensors (30) configured such that the vessel deck is fully viewable and the system capable of 360 degree visibility to the horizon.

In one or more embodiments, the inventive vessel system (100) may be pre-programmed and/or re-programmed and capable of continuously tracking multiple people at one time while the vessel is underway. If a man-overboard event does occur (i.e. person is the water event), the inventive vessel system immediately detects that a person is in the water and utilizing the plurality of sensor types (30, 35, 40, 50, 55); tracks the person in the water informing the vessel crew of the person or persons location. If a person known to be overboard and not visible or viewable due to waves or distance, it is contemplated that the inventive vessel system (100) may predict the location of the person or persons adrift based upon environmental conditions such as current, wind, weather, and time.

In one or more embodiments, the inventive vessel system (100) may concurrently with a man-overboard event occurring on an autonomous navigated vessel automatically navigate back on a safe approach for recovery of the man-overboard.

In one or more embodiments, the inventive vessel system (100) may be pre-programmed and/or re-programmed to concurrently with a man-overboard event occurring on a piloted (i.e. non-automated vessel), sound an alarm of man-overboard and record way points for recovery of the person(s) adrift. It is contemplated that the inventive vessel system (100) may be pre-programmed and/or re-programmed to display to vessel crew tracking imagery (30) of the person or persons adrift until recovery, including their location relative to the vessel.

In one or more embodiments, the inventive vessel system (100) may be pre-programmed and/or re-programmed and include multiple camera sensors (30) with the aid of radar and/or lidar (40) to detect approaching people by land or via another vessel.

In one or more embodiments, the inventive vessel system (100) may be pre-programmed and/or re-programmed such that while the vessel is on the water at anchor or underway, if another vessel approaches, the inventive vessel system (100) may provide an initial alert or warning of the approaching vessel with a horn signal or other type of signal.

In one or more embodiments, the inventive vessel system (100) may be pre-programmed and/or re-programmed such that while the vessel is underway if the vessel is capable of evading an approaching threating vessel, then the inventive vessel system (100) may attempt to outrun and/or outmaneuver the approaching threatening vessel to avoid illegal boarding.

In one or more embodiments, the inventive vessel system (100) may be pre-programmed and/or re-programmed so that in all cases, if a person illegally boards the vessel then an alarm sound. In an alternative embodiment, if an individual person can be recognized (i.e. identified), then an alarm will only sound when an unauthorize person boards the vessel.

In one or more embodiments, the inventive vessel system (100) may be pre-programmed and/or re-programmed and include a plurality of audio sensors (i.e. microphone-array) (35) to assist in navigation under low visibility scenarios or in response to distress signal. It is contemplated that inventive vessel system (100) via audio sensors (35) is capable of triangulation of sounds in the marine environment and recognize marine horn communications from vessels or distress signals such as human voice or whistle. In the case of distress from person in the water during a man-overboard event, the inventive vessel system (100) may navigate the vessel to avoid harming the person adrift and maneuver a safe approach for recovery. In the case, of communication for navigation in low visibility, the inventive vessel system (100) may take appropriate navigation actions per regional or international standards for collision prevention, including appropriately signaling back to the vessel with the horns.

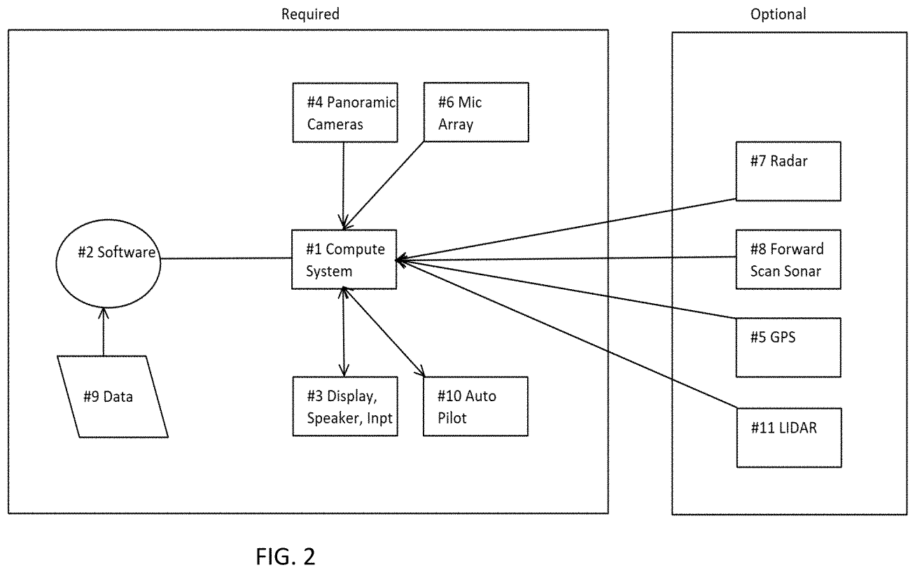

Referring to FIG. 2, a flowchart of required versus optional components of an embodiment of the invention is shown. FIG. 2 provides computer system #1 connected to software #2 with data #9, display/speaker input #3, panoramic cameras #4, a mic array #6, and auto pilot #10. Optionally, GPS #5, radar #7, forward scan sonar #8 and lidar #11 are provided.

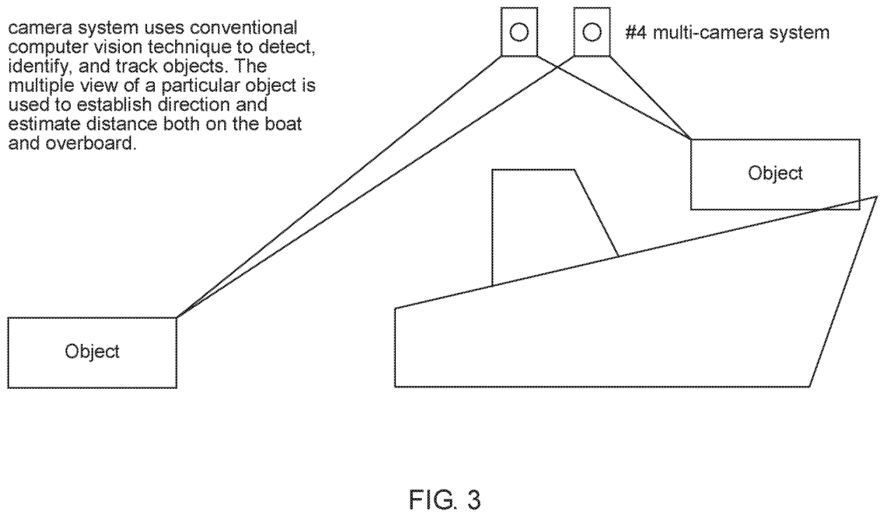

FIG. 3 shows a camera system on a vessel, such as a boat, which has multiple sensors (cameras), and is able to detect marine objects. In certain embodiments, the camera system uses conventional vision techniques to detect, identify and track marine objects. By providing multiple views of a particular object, a processor interpreting the multiple views can establish direction from the vessel tot the object both on the boat and when the vessel is overboard.

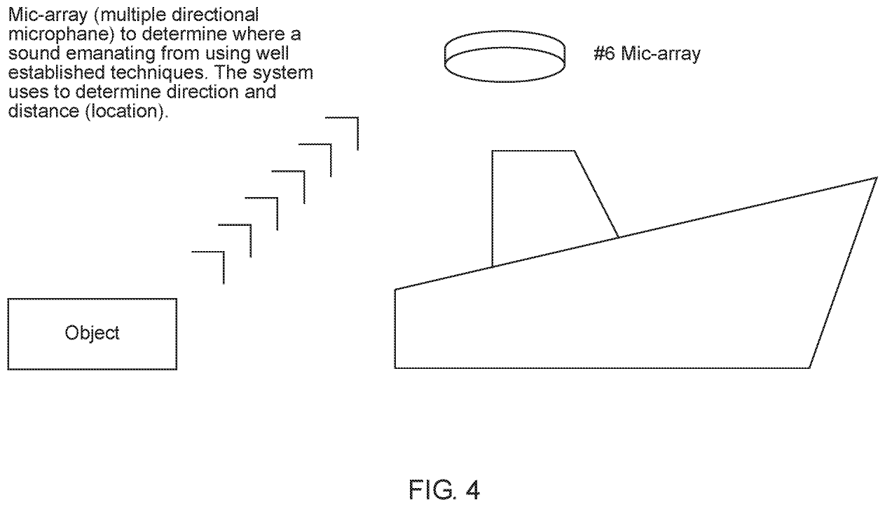

FIG. 4 shows a mic array #6 on board a vessel being used to detect and contextually recognize an object. Mic-array (multiple directional microphone) is used to determine where a sound is emanating from using well established techniques to determine direction and distance from an object.

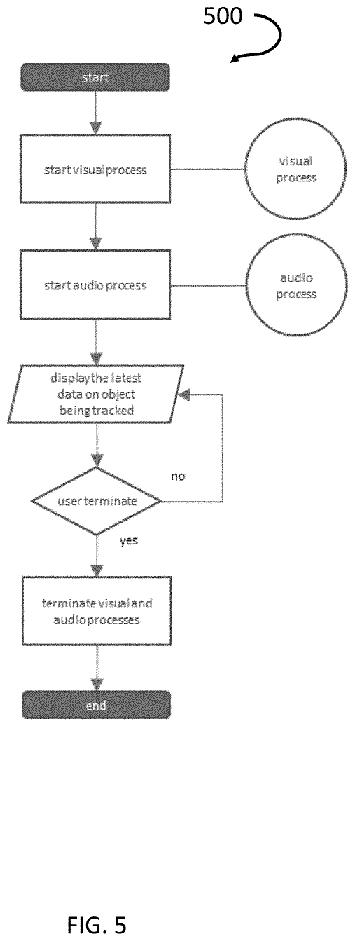

FIGS. 5-8 show various flow charts of embodiments of the invention.

FIG. 5 shows a smart visual process 500 having both visual and audio processes. The computer then displays data of an object being tracked and the user is able to terminate the video and audio processes.

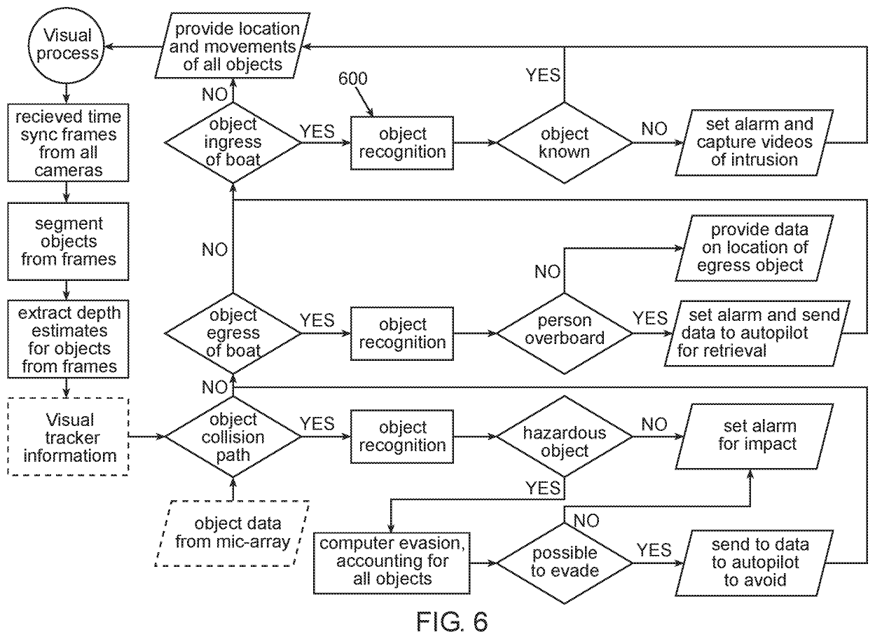

FIG. 6 shows flowchart 600 which is a visual process chart for object recognition and provides a decision tree as to various options for the software.

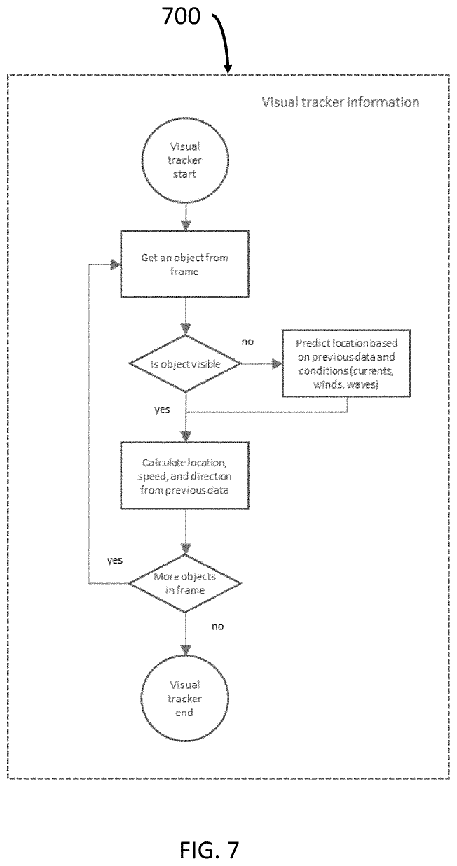

FIG. 7 shows a flowchart for the visual tracker information.

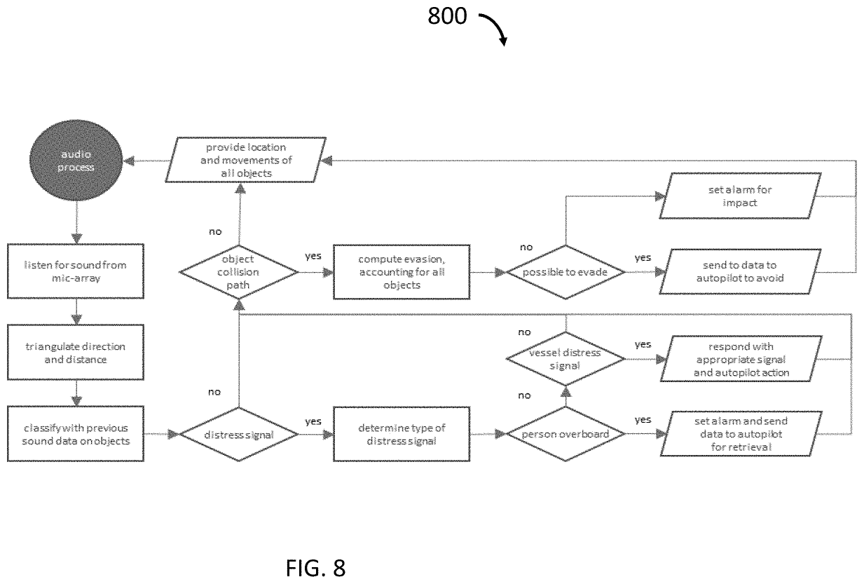

FIG. 8 shows a flowchart for an audio process for a man overboard event.

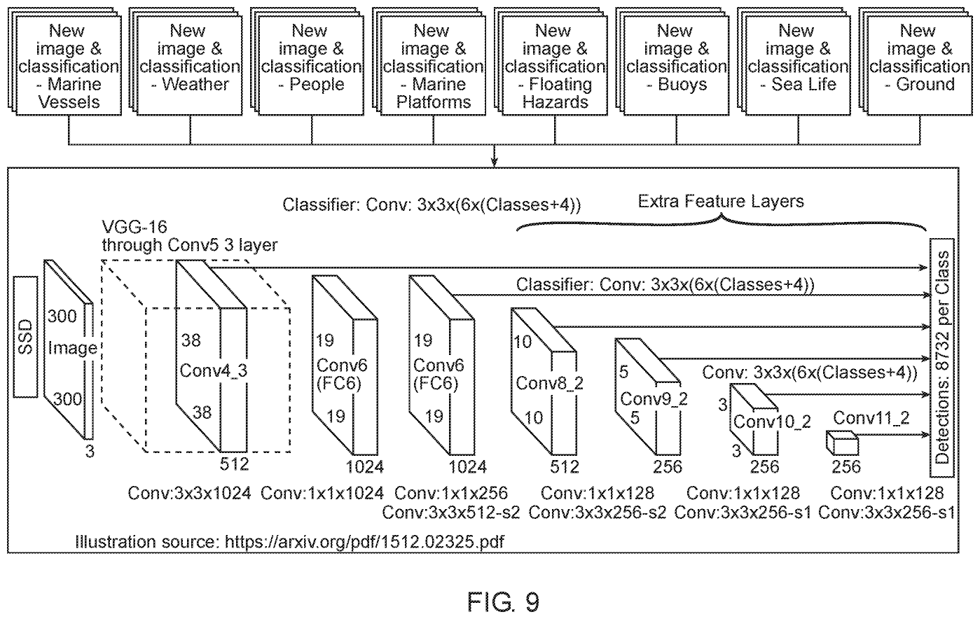

FIG. 9 shows an example of a neural network for object recognition. The neural network is able to classify various images into various classes. These images are stored on a database, such as a database onboard the mariner.

In certain embodiments, the system can perform machine learning on the database and can correlate items identified in various classes in the database with navigation maneuvers. For example if a type of rock is identified in a various class in a database, in a navigation maneuverer will be automatically performed so that the vessel will avoid the rock. The database will store additional images of the rock, so that the database is updated so future situations where a view of such a rock is encountered, additional navigations will be performed.

In one or more embodiments, the system transmits to a personal mobile device video and audio (No display needed). In one or more embodiments, the system has a CPU, GPU and DSP (digital signal processor).

In one or more embodiments, the system has initial omnibus training to recognize objects (General); then trained with specific stimuli from specific missions (Focused).

In one or more embodiments, the system has stimuli recognized in different situations (day, night, raining, clear, cloudy, etc.).

In one or more embodiments, the system provides pre-trained with general and/or focused information, such that any new stimuli with low confidence values are saved to improve the AI for the next mission (also “on-the-fly”).

In one or more embodiments, the system predicts a man overboard trajectory and plot the locations on the map, automatically navigate to man overboard.

In one or more embodiments, the system provides a contextual recognition to identify other vessels and transmit signals.

In one or more embodiments, the system has a list of authorized personnel to use the system such that the authorized personnel are recognized via facial recognition.

It is to be fully understood that certain aspects, characteristics, and features, of the invention, which are, for clarity, illustratively described and presented in the context or format of a plurality of separate embodiments, may also be illustratively described and presented in any suitable combination or sub-combination in the context or format of a single embodiment. Conversely, various aspects, characteristics, and features, of the invention which are illustratively described and presented in combination or sub combination in the context or format of a single embodiment, may also be illustratively described and presented in the context or format of a plurality of separate embodiments.

Although the invention has been described in conjunction with specific embodiments thereof, it is evident that many alternatives, modifications, and variations will be apparent to those skilled in the art. Accordingly, it is intended to embrace all such alternatives, modifications, and variations that fall within the spirit and broad scope of the appended claims.

What is claimed is:

1. A method for maritime hazard mitigation on a maritime vessel, the method comprising the steps of:
providing a maritime vessel;
providing a maritime hazard mitigation system onboard the maritime vessel, the maritime hazard mitigation system comprising:
at least one computer having a processor, software executing on the processor, and
a data storage, and
at least one sensor in communication with the at least one computer,
wherein maritime data is loaded onto the data storage, the maritime data including information stored on a database including a marine data model;
wherein upon operation of the maritime vessel, the maritime hazard mitigation system is configured to:
detect at least one maritime object via the at least one sensor;
associate the at least one maritime object with the marine data model stored on the database;
determine a navigation maneuver for the maritime vessel based upon the association between the at least one maritime object and the marine data model stored on the database; and
conduct a navigation maneuver by the maritime vessel.

2. The method of claim 1, wherein the at least one maritime object includes objects selected from a group consisting of boats, marine platforms, sea life, people, buoys, floating hazards, ground, weather, and combinations thereof.

3. The method of claim 1, wherein the step of associating the at least one maritime object with information stored on the database includes processing a machine learning algorithm.

4. The method of claim 1, wherein the marine data model is a neural network model.

5. The method of claim 1, wherein the marine data model stored on the database includes contextual responses to a possible vessel collision, a man-overboard scenario, and hostile or illegal vessel boarding information.

6. The method of claim 1, wherein the navigation maneuver of the maritime vessel is conducted autonomously without human intervention.

7. The method of claim 1, wherein the maritime hazard mitigation system is configured to recognize an emergency situation and provide a contextual based approach to performing the navigation maneuver to avoid the emergency situation.

8. A maritime hazard mitigation system, comprising:
a computer including a processor,
a data storage including a database storing information in communication with the processor, the data storage being loaded with information including a marine data model, and
software executing on the processor configured to detect at the least one maritime object via at least one image sensor via at least one sensor;
wherein the software executing on the processor compares the at least one maritime object with information stored on the database including the marine data model, and sends a corresponding signal to conduct a vessel navigation maneuver to avoid anticipated vessel collision with the at least one maritime object.

9. The system of claim 8, wherein the maritime hazard mitigation system is onboard the maritime vessel.

10. The system of claim 9, wherein the maritime vessel is autonomous and equipped with automated propulsion control and navigation control systems.

11. The system of claim 8, wherein the computer includes a neural network capable of heuristic machine learning to update the database with additional maritime and other information.

12. A system for contextual understanding for autonomous boat safety and security, comprising:
at least one imaging sensor,
at least one audio sensor,
a computer including a processor, a storage, network hardware, and a global positioning system (GPS),
the network hardware in communication with the computer and the at least one image sensor and the at least one audio sensor to establishing a local area network in further communication to with the Internet;
software executing on the processor for recognition of maritime objects via algorithms and digital signal processing;
a stream of data from the at least one image sensor and the at least one audio sensor configured to be analyzed and processed into a stream of environmental conditions and stimuli,
a set of pre-determined contexts stored in the storage relevant to maritime vessels in continuously changing environmental conditions; and,
a dynamic context derived by the computer based on the current state of the environmental conditions,
wherein the software executing on the processor continuously executes a decision algorithm that calculates an optimized vessel action based on the dynamic context.

13. The system of claim 12, wherein the dynamic contexts from the current state of the environment and optimized vessel action are displayed on an electronic display for viewing by a system user.

14. The system of claim 12, wherein the dynamic contexts from the current state of the environment and optimized vessel action are communicated to nearby mobile devices, vessels, and backup systems.

15. The system of claim 12, wherein the imaging sensor type is selected from the group consisting of visible wavelengths, hyperspectral wavelengths, infrared wavelengths, time-of-flight, depth of field or ranging, microwave wavelengths, radio wavelengths, and combinations thereof.

16. The system of claim 12, wherein the at least one audio sensor is selected from the group consisting of mic-array, microphone, sonar, ultrasound, sonic and combinations thereof.

17. The system of claim 12, wherein the algorithm utilizes data corresponding to local waterway rules or collision standards from the international standards for collision regulations,

18. The system of claim 12, wherein the dynamic context includes an intruding vessel determined by interception course and the optimized vessel action is to sound an alarm or evade.

19. The system of claim 12, wherein the dynamic context includes a man-overboard event and the optimized vessel action is to locate and track the man-overboard object.

20. The system of claim 12, wherein the dynamic context includes an object collision event and the software is configured to discriminate between a smart-avoiding object which can itself enact mutual avoidance directives, or a non-self-avoiding object where the optimized vessel action is to actively avoid collision with the non-self-avoiding object.
